(19) United States
(12) Patent Application Publication
(10) Pub. No.: US 2023/0115752 A1
(43) Pub. Date: Apr. 13, 2023

(54) SUPPLY UNIT FOR A HIGH-POWER LOAD AND ARRANGEMENT INCLUDING THE SUPPLY UNIT

(71) Applicant: Siemens Energy Global GmbH & Co. KG, München (DE)

(72) Inventors: Matthias Burkhardt, Bayreuth (DE); Andre Schön, Erlangen (DE)

(21) Appl. No.: 17/914,381

(22) PCT Filed: Mar. 24, 2020
(86) PCT No.: PCT/EP2020/058189

§ 371 Date: Sep. 26, 2022

(51) Int. Cl. H02M 1/00; H02M 7/162; H02J 3/38; H05B 7/144

(52) U.S. Cl. CPC H02M 1/0074; H02J 3/381; H02M 7/1626; H05B 7/144; F27B 3/085; H02J 2300/28

(57) ABSTRACT

A supply device for a high-power load includes a DC/DC voltage converter disposed between a high-voltage side and a low-voltage side. The DC/DC voltage converter includes a first sub-converter and a second sub-converter. The sub-converters are connected to one another in a converter series circuit between first and second primary-side DC voltage poles. The second sub-converter is connected between first and second secondary-side DC voltage poles. The sub-converters each have at least one AC voltage terminal connected to one another by a coupling device to permit an exchange of electrical power between the first and second sub-converters. The secondary-side DC voltage poles are configured for connection to the high-power load. An arrangement for converting electrical energy into chemical energy with gas generation includes the supply device.

The invention relates to a supply device for a high-power load.

High-power loads are energy consumers that require a high current of more than one kA, in particular of more than 5 kA. Examples of high-power loads are electric arc furnaces and electrolysis systems. The electrical energy supply or connection of high-power loads on an industrial scale (in particular in the power range above 100 MW) is currently mostly carried out using high-voltage or medium-voltage components and appropriate power electronics systems. These include in particular high-voltage and medium-voltage transformers, high-power rectifier circuits and the like. However, the solutions currently in use are not scalable or are scalable only to a limited extent with the power: the proportion of the costs for transformers and rectifier circuits or power electronic systems increases disproportionately as the power increases.

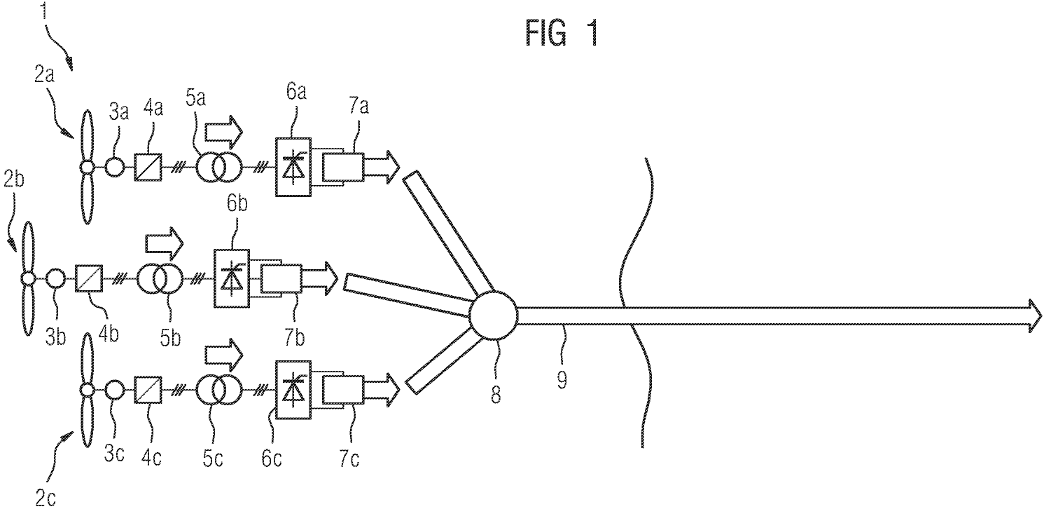

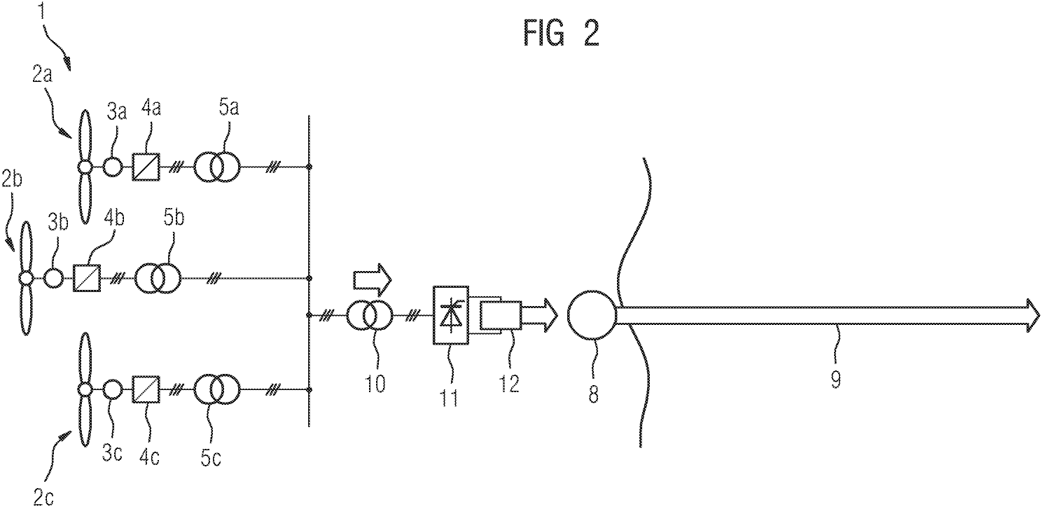

Possible examples of connecting an offshore wind farm for supplying energy to an electrolysis system are illustrated in FIGS. 1 and 2. In FIG. 1, a wind farm 1 consisting of a plurality of wind turbines 2a-2c is connected in a decentralized manner. Each wind turbine 2a-2c is connected to a respective electrolysis system 7a-7c via a separate turbine-internal generator 3a-3c and turbine-internal converter element 4a-4c and via a transformer 5a-5c associated with the respective wind turbine and having a likewise associated rectifier 6a-6c. The gas generated by means of the electrolysis systems 7a-7c is supplied to a central offshore gas terminal 8 and subsequently transported to land by means of a suitable gas transport infrastructure (for example gas pipeline, LNG tanker or reformed methanol) 9.

A central integration of a wind farm is shown in FIG. 2. According to the example of FIG. 2, the wind turbines 1a-1c are connected to a central rectifier 11 via a central offshore transformer 10. The central rectifier 11 supplies the electrical energy for operating an electrolysis system 12. The implementation examples shown in FIGS. 1 and 2 can be carried out in the offshore region only with a very high degree of outlay. In particular, with these solutions, both a gas-specific offshore infrastructure and subsequent preparation and transport systems are required to transport the chemically bonded energy from the offshore region to the onshore region.

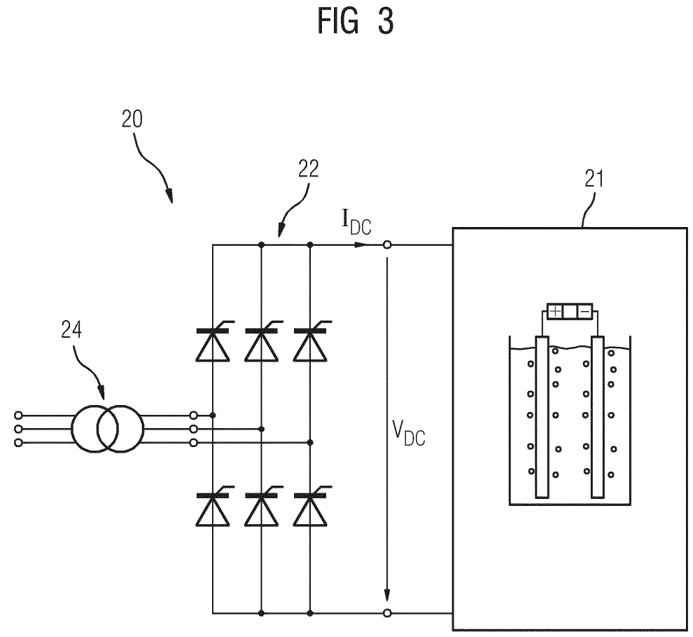

An example of a supply device 20 for an electrolysis system 21 according to the prior art is illustrated in FIG. 3. The supply device 20 comprises a thyristor-based converter element 22, the AC voltage side of which is able to be connected to an AC voltage grid by means of a grid transformer 24. A converter element current I_{DC} and a converter element voltage V_{DC} can be generated on the DC voltage side of the converter element 22 and these can be used to supply the electrolysis system 21. It can be seen that the scalability of the supply device 20 is relatively limited. As the electrical connection power of the electrolysis system 21 increases, disproportionately increasing costs in relation to the power electronics system, in particular the grid transformer 24 and the rectifier circuit of the converter element 22, can be expected.

For the reasons mentioned, there is a greater need for innovative solutions in relation to supplying energy to industrial-scale high-power loads.

The object of the invention is to propose a supply device or a high-power load that is as efficient and cost-effective as possible, in particular at high powers, and as reliable as possible.

The object is achieved according to the invention by way of a supply device for a high-power load comprising a voltage converter, wherein the voltage converter comprises a first sub-converter element and a second sub-converter element, wherein the sub-converter elements are connected to one another in a converter element series circuit between a first and a second primary-side DC voltage pole, wherein the second sub-converter element is connected between a first and a second secondary-side DC voltage pole, wherein the sub-converter elements each have at least one AC voltage terminal comprising a voltage converter, which terminals are connected to one another by means of a coupling device such that an exchange of electrical power between the first and the second sub-converter element is made possible, wherein the secondary-side DC voltage poles are set up for connection to the high-power load. The primary-side DC voltage poles of the voltage converter comprise a primary-side DC voltage terminal for connection to a primary-side voltage grid. The secondary-side DC voltage poles of the voltage converter likewise comprise a secondary-side DC voltage terminal for connection to a secondary-side DC voltage grid. Since the dielectric strength of the converter element series circuit is greater than the dielectric strength of one of the two sub-converter elements, the primary-side DC voltage grid can have an operating voltage greater than the operating voltage of the secondary-side DC voltage grid. The primary-side DC voltage terminal can therefore be referred to as high-voltage side and the secondary-side DC voltage terminal can be referred to as low-voltage side. The coupling device is set up to transmit an excess power dropped at the first sub-converter element to the second sub-converter element. One advantage of the supply device according to the invention is the scalability thereof, both in relation to the voltage to be generated and in relation to the output current to be supplied. Furthermore, the supply device according to the invention exhibits a higher power-electronics efficiency and a lower current loading of a transformer that may possibly be used in the coupling device in comparison with the prior art.

The first sub-converter element suitably comprises at least one first phase branch that extends between the first primary-side DC voltage pole and the secondary-side DC voltage pole and in which power semiconductors and a first AC voltage terminal are arranged. Furthermore, the second sub-converter element comprises at least one second phase branch that extends between the first secondary-side DC voltage pole and the second secondary-side DC voltage pole and in which power semiconductors and a second AC voltage terminal are arranged, wherein the AC voltage terminals are connected to one another by means of the coupling device. The power semiconductors are expediently controllable power semiconductor switches that can be switched on and/or off and that are able to be controlled by means of a suitable closed-loop or open-loop control device. The respective number of power semiconductors in each phase branch is basically arbitrary and can be adapted to the respective application. The scalability of the supply device in relation to the voltage is produced in particular from the number of power semiconductors used that can be determined accordingly. The scalability of the supply device in relation to the current is produced from the fact that the number of phase branches in each sub-converter element is likewise basically arbitrary and able to be adapted to the respective application. For this purpose, each of the sub-converter elements can comprise a plurality of parallel-connected phase branches, for example of identical design.

The coupling device suitably comprises a coupling transformer, the primary side or primary winding of which is connected to the first AC voltage terminal of the first sub-converter element and the secondary side or secondary winding of which is connected to the first AC voltage terminal of the second sub-converter element. In this way, the two sub-converter elements are inductively coupled with a galvanic isolation between the two AC voltage terminals. In order to be able to realize an additional outgoing circuit to a connected AC voltage system, a three-winding transformer or a coupling device with comparable functionality can also suitably be used, as is explained in more detail below.

As already mentioned above, the supply device is particularly advantageously able to the used in a high-power load, which is an electrolysis system (or fuel cell) or an electric arc furnace.

According to one embodiment of the invention, the second sub-converter element is a line-commutated sub-converter element, in particular a thyristor-based sub-converter element. A line-commutated sub-converter element is characterized in particular in that the commutation processes during operation thereof are usually determined by the connected grid. A line-commutated converter element can comprise power semiconductors that can be switched on but not off. A thyristor-based sub-converter element accordingly comprises a series circuit of thyristors in the phase branch thereof, preferably in each phase branch. The use of a line-commutated sub-converter element advantageously enables a robust system design and can be scaled over a particularly large power range.

The second sub-converter element may be a passive sub-converter element, in particular a diode-based sub-converter element. The diode-based sub-converter element comprises in each of the phase branches thereof a series circuit of power diodes. The use of passive power semiconductors such as diodes makes it possible to achieve a particularly robust system design.

According to another embodiment of the invention, the second sub-converter element is a double-thyristor-based sub-converter (antiparallel thyristors). The sub-converter element comprises in each of the phase branches thereof a series circuit of thyristor switching elements, wherein each thyristor switching element has thyristors connected in antiparallel. Energy recovery can be made possible by means of such a bidirectional thyristor bridge. In the event of a reversible electrolysis/fuel cell system being connected, the reconversion of H₂ to electricity in terms of the process leads to a lower DC voltage, with the result that a particular advantage here consists in the low-voltage-side DC voltage being able to be reduced to 0 kV in a variable manner.

It should be noted here that all of the previously mentioned line-commutated topologies can be designed with six pulses but can also be designed with more pulses (a12, 18, ...) . In addition, the corresponding sub-converter elements can be designed with any number of phases.

According to a preferred embodiment of the invention, the first sub-converter element is what is known as a modular multilevel converter element (MMC). An MMC comprises in the (each) phase branch a series circuit of switching modules. Each of the switching modules has power semiconductors that can be switched off and an energy store in the form of a switching module capacitor. The switching modules may be suitably grouped in the phase branch so that two power converter arms are formed, between which the AC voltage terminal is arranged. If the first sub-converter element is embodied as an MMC and the second sub-converter element is embodied as a line-commutated or passive converter element, the excellent voltage scalability of the MMC can be particularly advantageously combined with the high current-carrying capacity of the second sub-converter element.

The first sub-converter element can comprise switching modules by means of which unipolar switching module voltages can be generated, in particular half-bridge switching modules. This type of switching module is characterized in particular in that a positive switching module voltage (that corresponds to an energy storage voltage present at the energy store of the relevant switching module) or a zero voltage can be generated at the terminals of said switching modules. The advantage of such switching modules is their relatively simple construction and relatively low losses during operation. In this configuration, it is possible to achieve a particularly high efficiency of the supply device.

As an alternative thereto, the first sub-converter element can comprise switching modules by means of which bipolar switching module voltages can be generated, in particular full-bridge switching modules. Full-bridge switching modules are characterized in that a bipolar voltage can be generated at the terminals of said switching modules, that is to say both a positive and a negative switching module voltage. The magnitude of the switching module voltage substantially corresponds to an energy storage voltage present at the energy store of the full-bridge switching module. The switching modules of this type have the advantage of being able to build up an opposing voltage where necessary. Feedback of the low-voltage side (high-current side) to the DC fault can thus be prevented. In this way, it is thus advantageously possible to protect the sub-converter element in the event of short circuits on the high-voltage side.

According to one embodiment of the invention, both the first and the second sub-converter element comprise half-bridge switching modules and/or full-bridge switching modules. If both the first and the second sub-converter element are designed based on transistors or as MMCs, both the DC voltage current on the secondary side or low-voltage DC side and the secondary-side output voltage and the DC voltage converter can then be set almost optimally. In addition, the proportion of current and voltage can advantageously be minimized. As an alternative thereto, in particular the second sub-converter element can be embodied as a two-level or three-level converter element known from the prior art due to the comparatively low DC output voltage.

It may be advantageous if a DC breaker which is connected to one of the primary-side or high-voltage side DC voltage poles is provided. A DC breaker of this type can be used to protect against short circuits of the high-voltage side of the voltage converter.

The voltage converter is preferably designed for voltage conversion at a voltage transformation ratio of the primary side to the secondary side voltage of 2 to 20. The power range of the DC voltage converter is preferably between 1 MW and 1000 MW. The DC voltage on the high-voltage side is scaled approximately from one kV to above the 1 MV limit in order to match the power range.

The two sub-converter elements are each expediently designed to have at least two phases. The first sub-converter element accordingly comprises at least one first phase branch that extends between the first primary-side DC voltage pole and the secondary-side DC voltage pole and in which power semiconductors and a first AC voltage terminal are arranged. The second sub-converter element accordingly comprises at least one second phase branch that extends between the first secondary-side DC voltage pole and the second secondary-side DC voltage pole and in which power semiconductors and a second AC voltage terminal are arranged. The arrangement is able to be extended accordingly to three and more phases in the manner shown.

According to a preferred embodiment of the invention, the coupling device has a coupling terminal which is set up to connect the arrangement to an AC voltage grid. Power can thus be exchanged with the AC voltage grid. In this way, it is possible to connect the supply device both to a DC voltage grid and to an AC voltage grid. The coupling terminal is preferably a tertiary winding of a coupling transformer. In this context, a two-winding transformer for each sub-converter element is possible, instead of three-winding transformers.

With a view to further increasing the low-voltage-side terminal power or direct current on the low-voltage side of the voltage converter, the supply device or the voltage converter can comprise a third sub-converter element which is connected to the second sub-converter element in a converter element parallel circuit. The third and possibly the further sub-converter element can be designed in the same way as the second sub-converter element, but do not necessarily have to be.

The invention furthermore relates to an arrangement for converting electrical energy into chemical energy to generate hydrogen/gas. Such a process may be present for example in electrolysis, in which electrical energy is converted into a gas as energy carrier of the chemical energy. The gas may be hydrogen, for example. The gas generated is transported to a place of consumption by means of appropriate lines (for example a pipeline) after the electrolysis.

An arrangement of this type can be used in the context of connecting a wind farm to an electrolysis system, which has already been described above.

The object of the invention is to specify an arrangement of this type that is as cost-effective as possible in production and operation and is as reliable as possible.

The object is achieved according to the invention by way of an arrangement for converting electrical energy into chemical energy to generate gas comprising an energy generation system by means of which electrical energy can be provided and said energy can be transmitted by means of a DC transmission path, and a supply device according to the invention, wherein the primary side of the supply device is connected to the DC transmission path. The advantages of the arrangement according to the invention result in particular from the advantages of the supply device according to the invention that have already mentioned.

The energy generation system suitably comprises a rectifier by means of which the energy generation system is connected to the DC transmission path. The electric energy is accordingly first fed into an AC voltage grid and converted to DC voltage by means of the rectifier. This makes it possible to connect, for example, wind farms that conventionally generate an AC voltage. The rectifier may also be a unidirectional rectifier, for example a diode rectifier.

According to one embodiment of the invention, the coupling device of the DC voltage converter has a coupling terminal which is connected to a supply grid. The primary side of the supply device can accordingly be connected to the rectifier and the secondary side can be connected to the electrolysis system. In addition, the supply device can be connected to supply grid. In this way, it is possible for the energy that is transmitted via the DC voltage grid or the DC voltage line to be used on the one hand to supply the electrolysis system with energy and on the other hand, for example, to feed any excess energy into the supply grid or to draw same as required. In addition, it may be made possible to feed chemically bonded energy as current back into the supply grid and to reconvert hydrogen to electricity (reversible electrolysis/fuel cell operation) without additional current reconversion systems.

The patent or application file contains at least one drawing executed in color. Copies of this patent or patent application publication with color drawing(s) will be provided by the Office upon request and payment of the necessary fee.

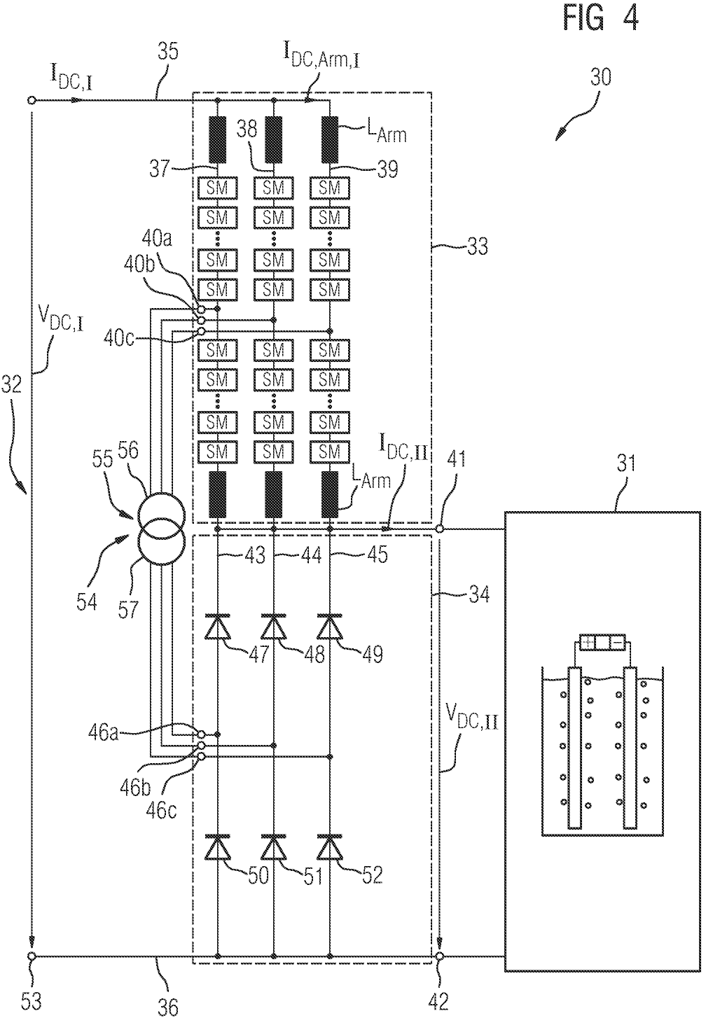

The invention is explained in more detail below in connection with FIGS. 4 to 19.

FIG. 4 shows a schematic illustration of a first exemplary embodiment of a supply device according to the invention;

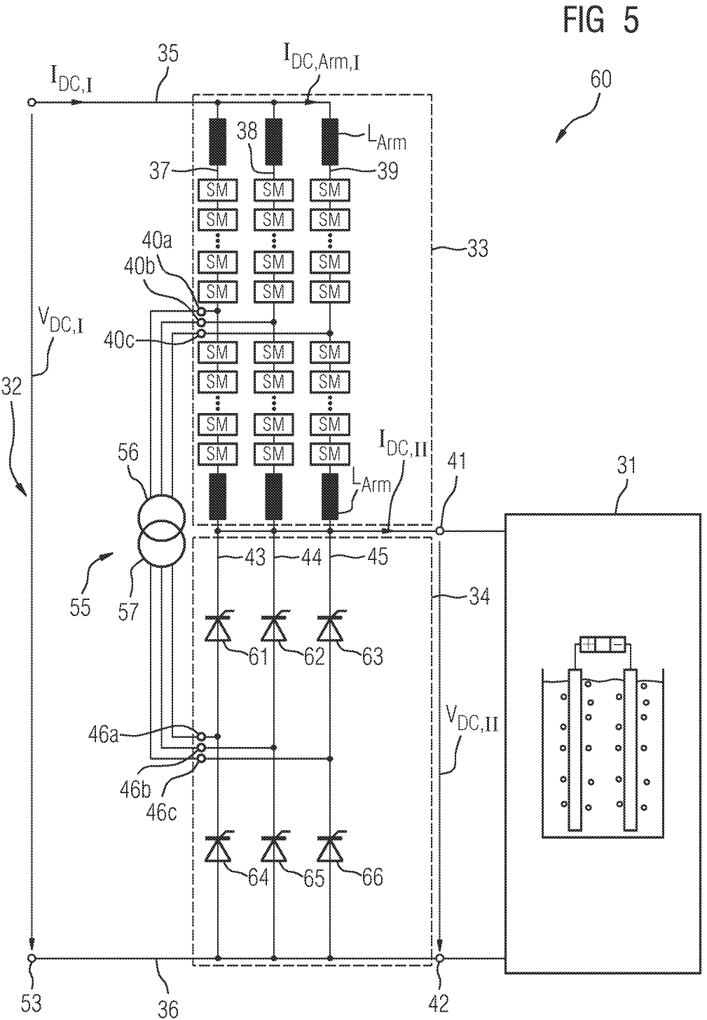

FIG. 5 shows a schematic illustration of a second exemplary embodiment of a supply device according to the invention;

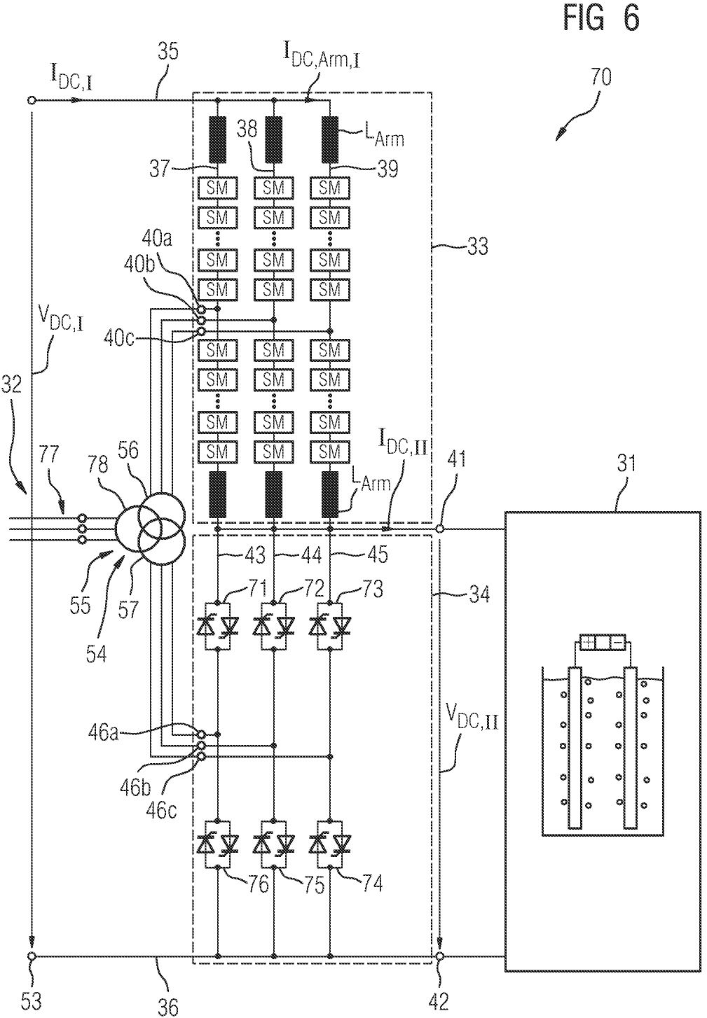

FIG. 6 shows a schematic illustration of a third exemplary embodiment of a supply device according to the invention;

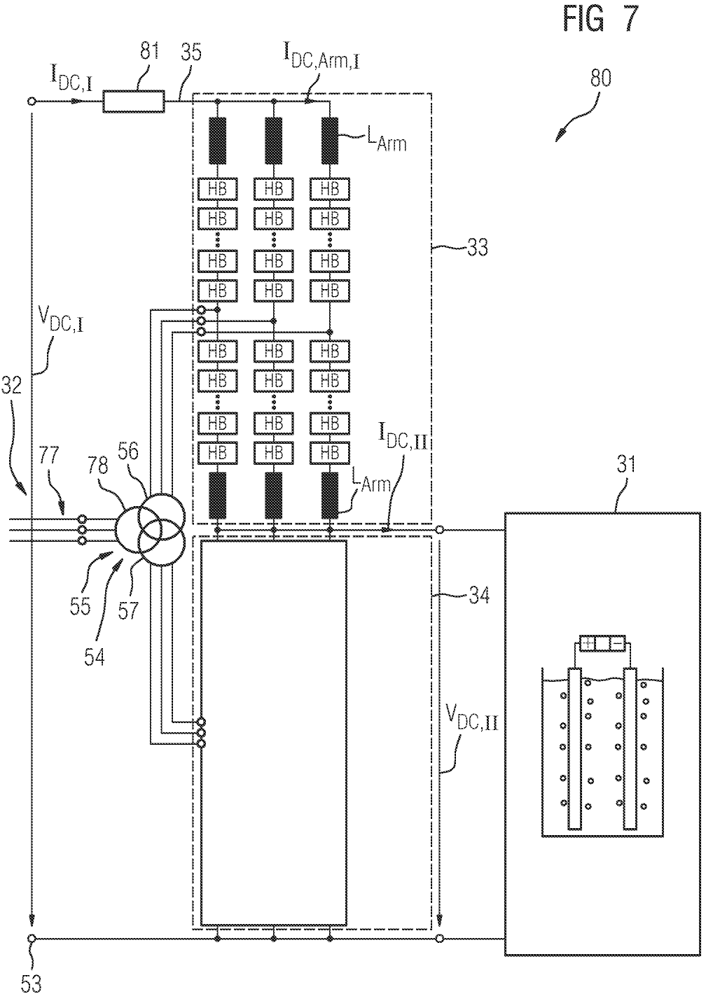

FIG. 7 shows a schematic illustration of a fourth exemplary embodiment of a supply device according to the invention;

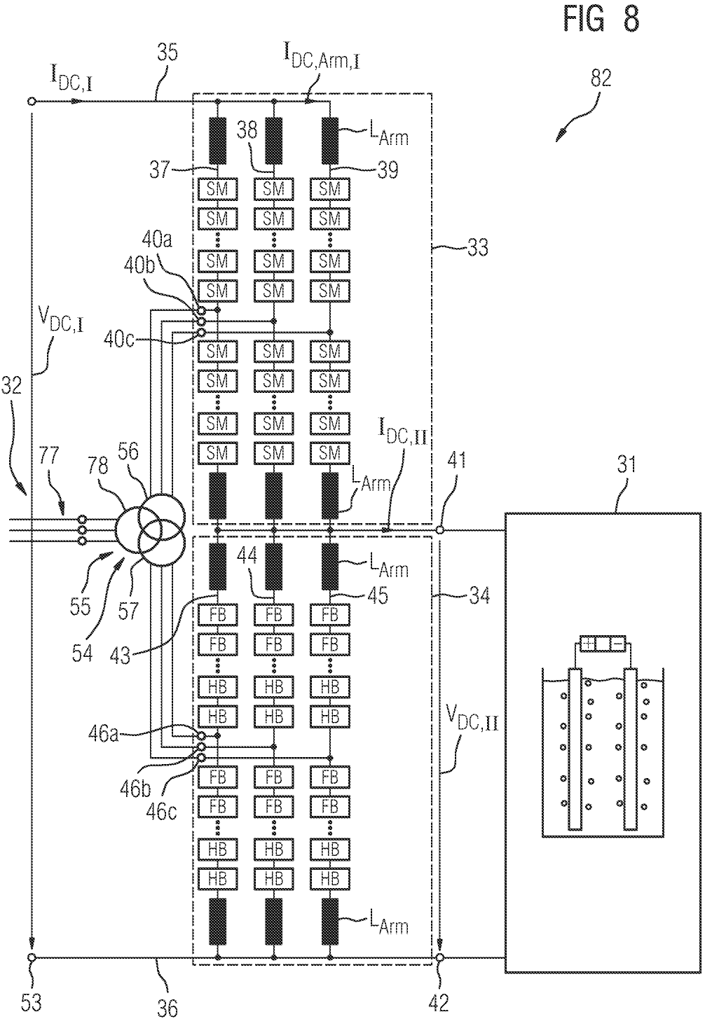

FIG. 8 shows a schematic illustration of a fifth exemplary embodiment of a supply device according to the invention;

FIG. 9 shows a schematic illustration of an example of a switching module for a supply device according to the invention;

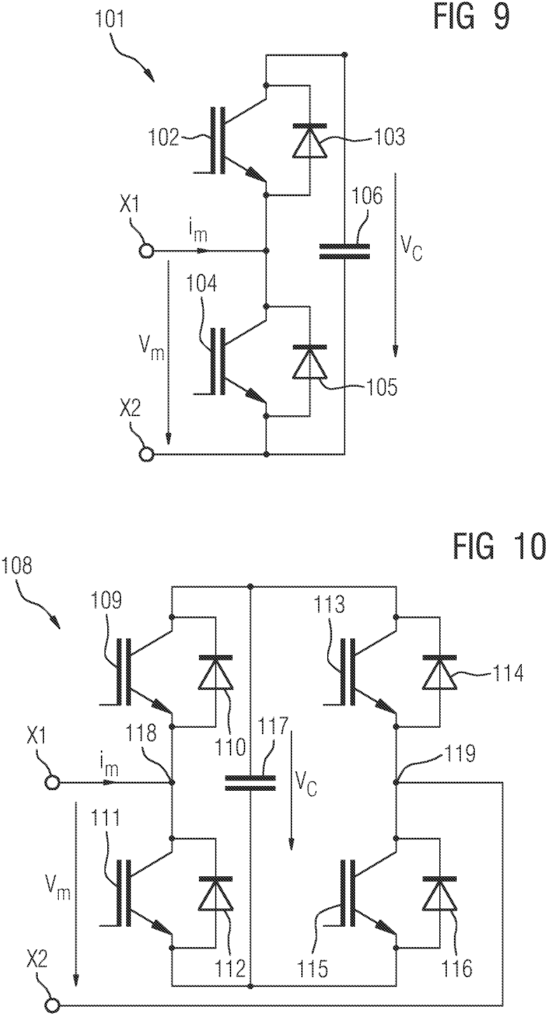

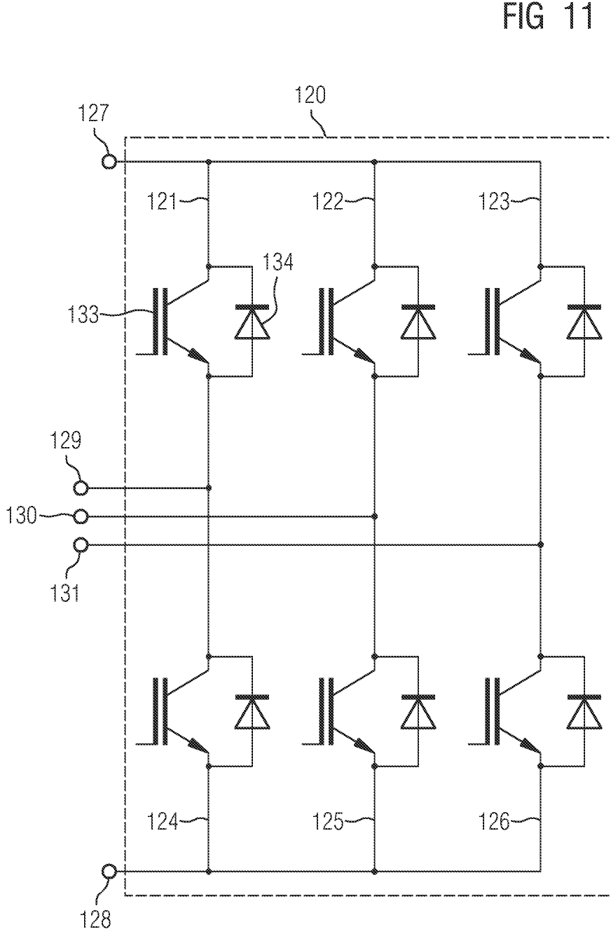

FIG. 10 shows a schematic illustration of another example of a switching module for a supply device according to the invention;

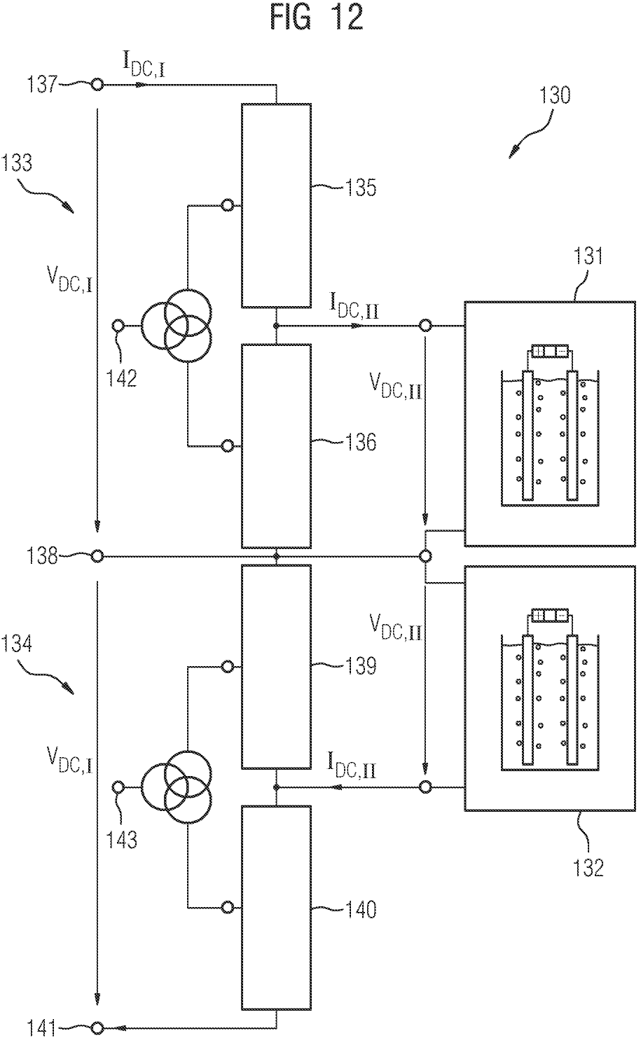

FIG. 11 shows a schematic illustration of an example of a sub-converter element for a supply device according to the invention;

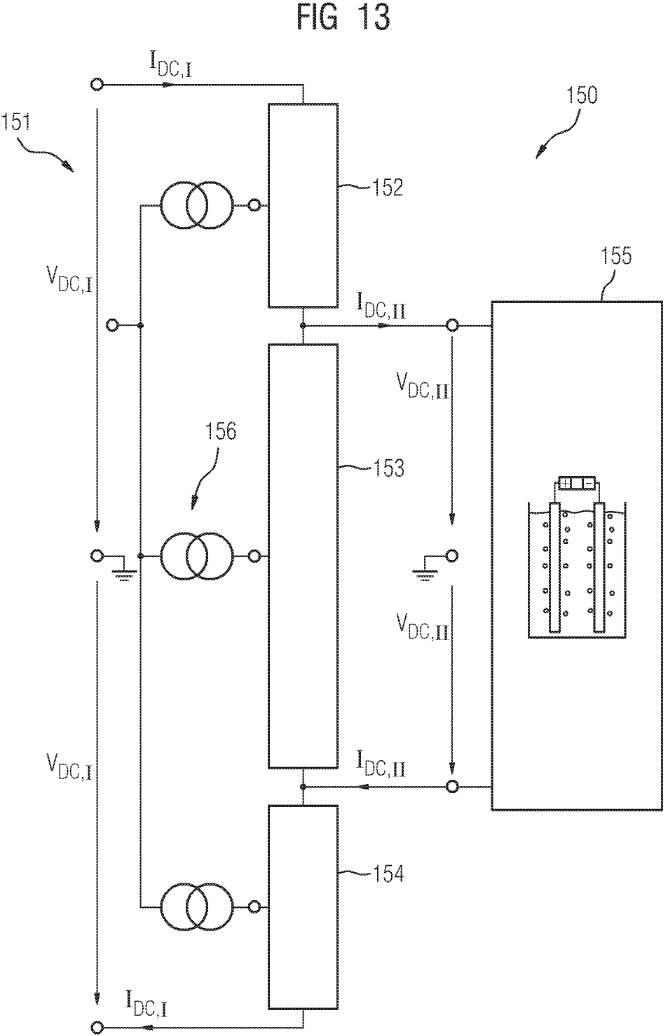

FIG. 12 shows a schematic illustration of a sixth exemplary embodiment of a supply device according to the invention;

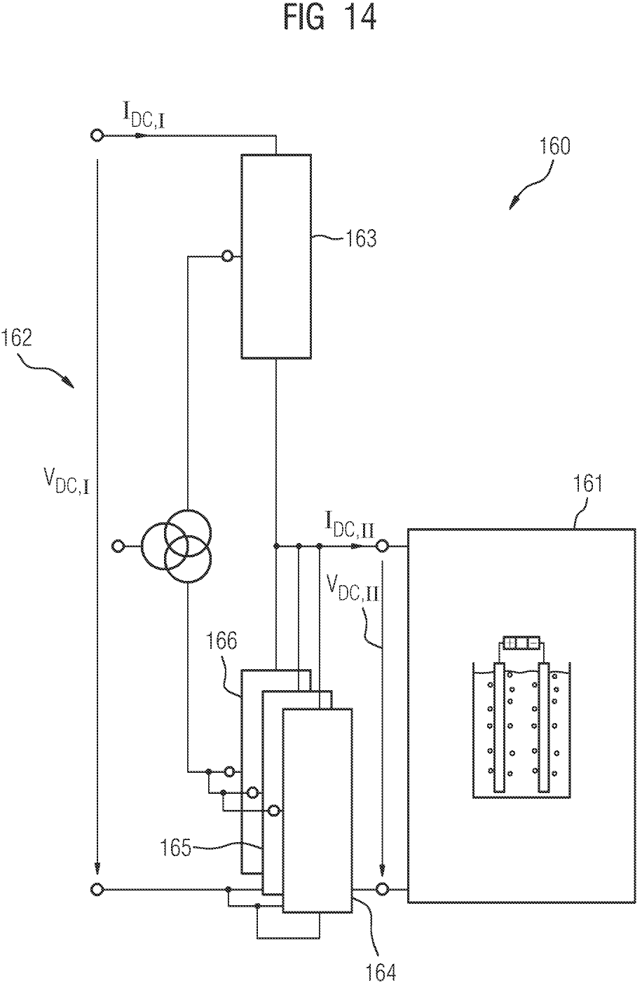

FIG. 13 shows a schematic illustration of a seventh exemplary embodiment of a supply device according to the invention;

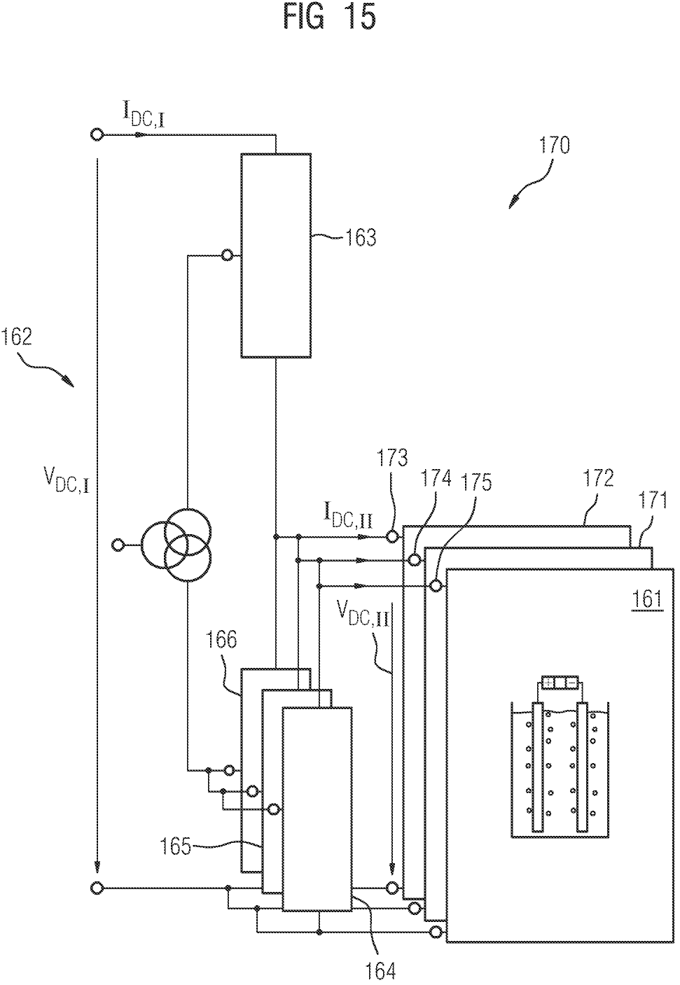

FIG. 14 shows a schematic illustration of an eighth exemplary environment of a supply device according to the invention;

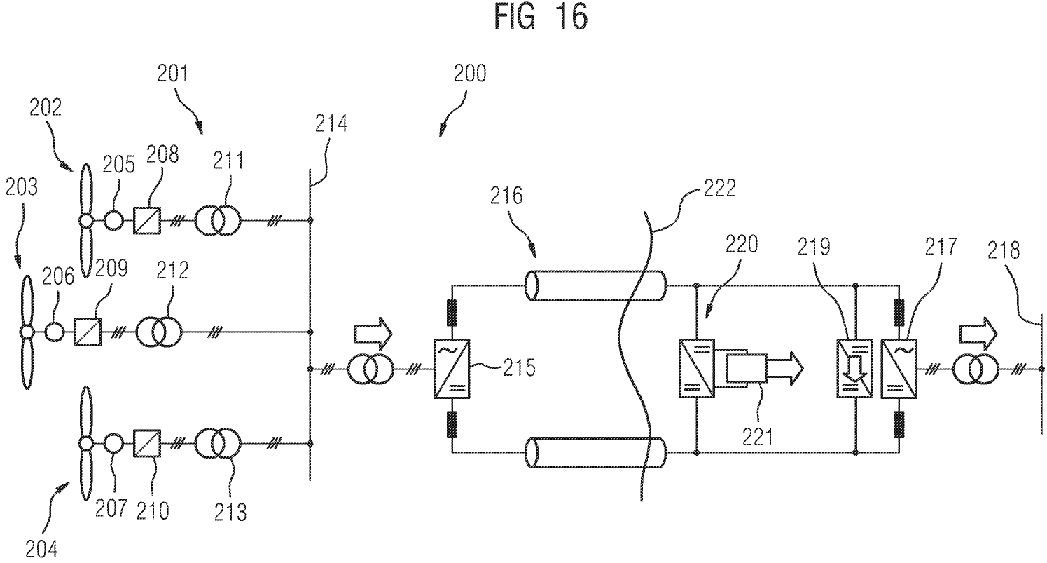

FIG. 15 shows a schematic illustration of a ninth exemplary environment of a supply device according to the invention;

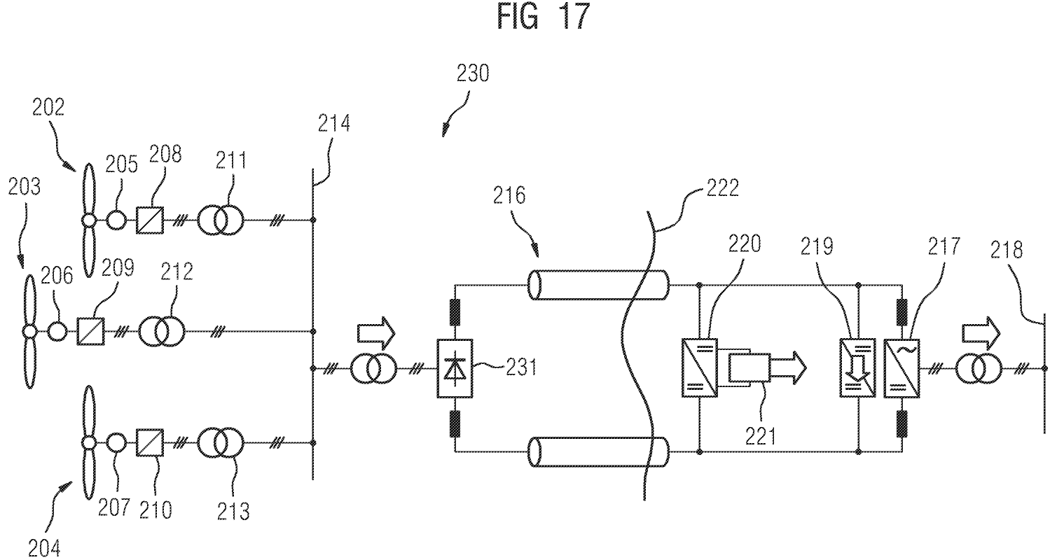

FIG. 16 shows a schematic illustration of a first exemplary embodiment of an arrangement according to the invention for converting electrical energy into chemical energy to produce gas;

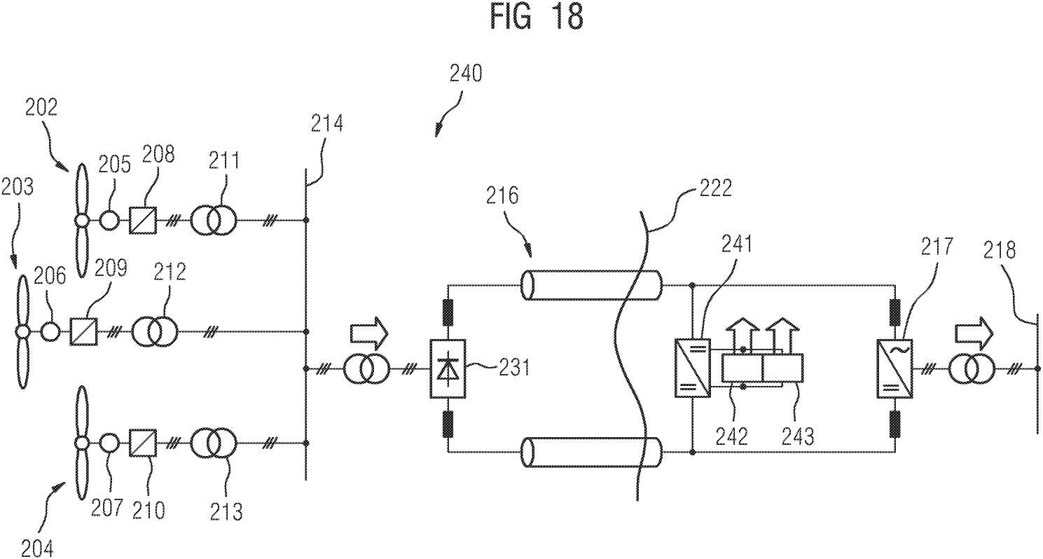

FIG. 17 shows a schematic illustration of a second exemplary embodiment of an arrangement according to the invention for converting electrical energy into chemical energy to produce gas;

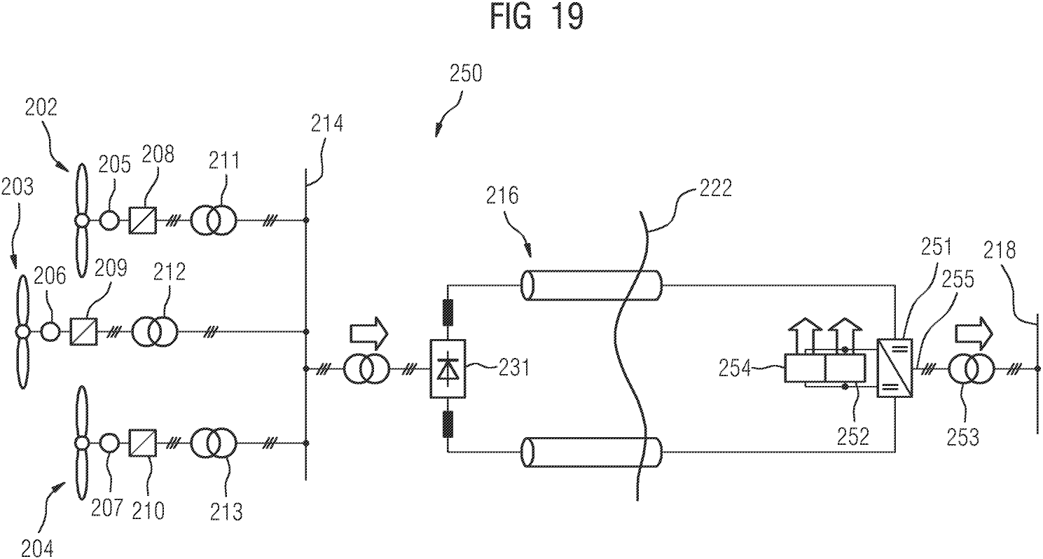

FIG. 18 shows a schematic illustration of a third exemplary embodiment of an arrangement according to the invention for converting electrical energy into chemical energy to produce gas;

FIG. 19 shows a schematic illustration of a fourth exemplary embodiment of an arrangement according to the invention for converting electrical energy into chemical energy to produce gas.

The supply device 30 comprises a DC voltage converter 32. The DC voltage converter 32 comprises a first sub-converter element 33 and a second sub-converter element 34 which are connected to one another in a converter element series circuit which extends between a first primary-side DC voltage pole 35 and a second primary-side DC voltage pole 36.

The first sub-converter element 33 is formed with three phases. It comprises a first phase branch 37, a third phase branch 38 and a fifth phase branch 39. The three phase branches 37-39 each connect the first primary-side DC voltage pole 35 to a first secondary-side DC voltage pole 41. The first phase branch 37 has a first AC voltage terminal 40a, the third phase branch 38 has a third AC voltage terminal 40b, the fifth phase branch 39 has a fifth AC voltage terminal 40c. The first sub-converter element 33 is a modular multilevel converter (MMC). A series circuit of switching modules SM is arranged in a first converter element arm of the first sub- converter element 33 that extends between the first primary-side DC voltage pole 35 and the first AC voltage terminal 40a. The construction of the switching modules SM according to the example illustrated here is dealt with in more detail below based on FIGS. 9 and 10. Each of the switching modules SM generally comprises a plurality of power semiconductors that can be switched off (such as transistors that can be switched off, for example) and a module-specific energy store, usually in the form of a switching module capacitor. A second converter arm of the first sub-converter element 33 between the first AC voltage terminal 40a and the first secondary-side DC voltage pole 41 comprises a further series circuit of switching modules SM. Both converter arms also have an arm inductance Larm. The other two phase branches of the first sub-converter element 33 are designed in substantially the same way as the first phase branch 37.

The second sub-converter element 34 is a diode-based, passive converter element designed with three phases. It comprises a second phase branch 43, a fourth phase branch 44 and a sixth phase branch 45 which connect the first secondary-side DC voltage pole 41 to a second secondary-side DC voltage pole 42. Each of the three phase branches 43-45 has a respective assigned AC voltage terminal 46a, 46b and 46c. Each of the three phase branches 43-45 also has two converter element arms: a first or upper converter element arm between the first secondary-side DC voltage pole 41 and the respectively assigned AC voltage terminal 46a-c and a second or lower converter element arm between the assigned AC voltage terminal 46a-c and the second secondary-side DC voltage pole 42. Each of the converter element arms of the second sub-converter element 34 comprises a series circuit of high-power diodes 47, 48, 49, 50, 51 and 52.

A second primary-side DC voltage pole 53 is directly connected to the second secondary-side DC voltage pole 42.

A primary-side voltage present at the primary-side DC voltage poles 35, 53 is referred to as V_{DC1}. A secondary-side voltage present at the secondary-side DC voltage poles 41, 42 is referred to as V_{DC2}. A primary-side current I_{DC1} flows on the primary side, a secondary-side current I_{DC2} flows on the secondary side.

The supply device 30 also comprises a coupling device 54 for exchanging energy between the sub-converter elements 33, 34. The coupling device 54 connects the AC voltage terminals 40a-c of the first sub-converter element 33 to the AC voltage terminals 46a-c of the second sub-converter element 34. The coupling device 54 comprises a coupling transformer 55 having a primary side or primary winding 56 that is connected to the first sub-converter element 33 and having a secondary side or secondary winding 57 that is connected to the second sub-converter element 34.

The supply device 30 also comprises a closed-loop control device for carrying out closed-loop voltage, current and/or power control (not illustrated in the figures, however). The closed-loop control device can comprise an actuation device set up to actuate all of the controllable power semiconductors of the supply device 30.

FIG. 5 illustrates a further supply device 60. Identical and similar components and elements are provided with the same reference signs in FIGS. 4 and 5. This also applies otherwise to the following FIGS. 6 to 8. For reasons of clarity, the following text deals only with the differences between the supply device 30 of FIG. 4 and the supply device 60.

In contrast to the supply device 30, the supply device 60 comprises a DC voltage converter 32, the second sub-converter element 34 of which is based on thyristors. This means that a series circuit of thyristors 61-66 is arranged in each of the three phase branches 43-45 or in each of the six corresponding converter element arms.

FIG. 6 illustrates a supply device 70. In contrast to the supply device 60 of FIG. 5, (series circuits of) switching units 71-76 comprise in each converter element arm of the phase branches 43-45 the respective thyristors connected in antiparallel. The use of the double-thyristor circuits (antiparallel thyristors) permits energy to be recovered into a connected AC voltage grid 77 without reversing the DC voltage. To this end, a tertiary winding 78 by means of which the supply device 70 able to be connected to the AC voltage grid 77 is provided at the coupling transformer 55.

FIG. 7 illustrates a supply device 80. In contrast to the supply device 70 of FIG. 6, the switching modules SM of the first sub-converter element 33 are specifically designed as half-bridge switching modules HB. The following text deals with the construction of the half-bridge switching modules HB in more detail in connection with FIG. 9.

The supply device 80 also comprises a DC breaker 81 which is arranged at the first primary-side DC voltage pole 35 such that the DC voltage converter 32 is connected to the primary-side DC voltage grid or the DC voltage line via the DC breaker 81. In the event of a fault (for example short circuit) on the primary-side DC voltage side, the DC breaker 81 can be used to protect the DC voltage converter.

FIG. 8 illustrates a supply device 82 for supplying the high-power load 31. In contrast to the supply devices of the preceding figures, both sub-converter elements 33 and 34 are formed as modular multilevel converter elements. The phase branches 37-39 and 43-45 each accordingly comprise series circuits of switching modules having respective power semiconductor switches and switching-module-specific energy stores. In this case, both half-bridge switching modules HB and full-bridge switching modules FB are provided in each of the total of twelve converter element arms that extend in each case between one of the DC voltage poles 35, 41, 42, 53 and one of the AC voltage terminals 40a-c, 46a-c. The following text deals in more detail with the construction of the half-bridge and full-bridge switching modules in connection with FIGS. 9 and 10. The full-bridge switching modules can be used to protect the DC voltage converter 32 in the event of a fault since they are suitable for building up an opposing voltage that can reduce or prevent a short-circuit current through the DC voltage converter 32.

FIG. 9 shows a half-bridge switching module 101. The half-bridge switching module 101 has two terminals X1 and X2. The terminal X1 can for example connect the half-bridge switching module 101 to the terminal X2 of another half-bridge switching module so that a series circuit of the half-bridge switching modules is formed.

The half-bridge switching module 101 comprises a first semiconductor switch 102 in the form of an insulated-gate bipolar transistor (IGBT), with which a freewheeling diode 103 is connected in antiparallel. The half-bridge switching module 101 also comprises a second semiconductor switch 104 in the form of an IGBT, with which a freewheeling diode 105 is connected in antiparallel. The forward direction of the two semiconductor switches 102 and 104 is aligned. The first terminal X1 is arranged at a potential point 113 between the two semiconductor switches 102 and 104. The second terminal X2 is connected to the emitter of the second semiconductor switch 104.

An energy store in the form of a high-power capacitor 106 is arranged in parallel with the two semiconductor switches 102, 104. In the case of an operating current direction indicated by an arrow, the capacitor 106 can be connected or bypassed through suitable actuation of the semiconductor switches 102, 104 so that a switching module voltage Vₘ is present at the terminals X1, X2, said switching module voltage corresponding either to the voltage V_{c} dropped at the capacitor 106 or to a voltage of zero.

FIG. 10 schematically illustrates an example of a full-bridge switching module 108. The full-bridge switching module 108 has a first semiconductor switch 109 in the form of an IGBT, with which a freewheeling diode 110 is connected in antiparallel, and also a second semiconductor switch 111 in the form of an IGBT, with which a freewheeling diode 112 is connected in antiparallel. The forward direction of the two semiconductor switches 109 and 111 is aligned. The full-bridge switching module 108 also comprises a third semiconductor switch 113 in the form of an IGBT, with which a freewheeling diode 114 is connected in antiparallel, and also a fourth semiconductor switch 115 in the form of an IGBT, with which a freewheeling diode 116 is connected in antiparallel. The forward direction of the two semiconductor switches 113 and 115 is aligned. The semiconductor switches 109 and 111 therefore form together with the freewheeling diodes 110, 112 associated therewith a series circuit that is connected in parallel with a series circuit formed by the semiconductor switches 113, 115 and the associated freewheeling diodes 114 and 116. An energy store in the form of a high-power capacitor 117 is arranged in parallel with the two series circuits. The first terminal X1 is arranged at a potential point 118 between the semiconductor switches 109, 111, the second terminal X2 is arranged at a potential point 119 between the semiconductor switches 113, 115.

In the case of a given current through the switching module, the switching module voltage Vₘ dropped at the terminals X1, X2 can be generated through suitable control of the power semiconductors 109, 111, 113 and 115, said switching module voltage corresponding to an energy storage voltage V_{c} dropped at the capacitor 117, to the energy storage voltage dropped at the capacitor 117 but with opposite polarity, or to a voltage of zero.

FIG. 11 illustrates a sub-converter element 120 that can be used as the first and/or the second sub-converter element 33 or 34 of the DC voltage converter 32 of the preceding figures. The sub-converter element 120 is formed with three phases and comprises six converter element arms 121-126 which each extend between one of the DC voltage poles 127, 128 and one of the AC voltage terminals 129-131. A series circuit of switching elements (represented in the figures by a single switching element 132) is arranged in each of the converter element arms 121-126, with each switching element 132 comprising a semiconductor switch 133 that can be switched off (IGBT as shown in the figure, IGCT, GTO or the like) and a diode 134 connected in antiparallel therewith. The sub-converter element 120 is often referred to as a two-level converter.

FIG. 12 illustrates a supply device 130 that is designed for bipolar configuration. The supply device is suitable for supplying a first and a second high-power load 131 and 132.

The supply device 130 comprises a first DC voltage converter 133 and a second DC voltage converter 134. The first voltage converter 133 has a first converter element series circuit with a first sub-converter element 135 and a second sub-converter element 136, the converter element series circuit extending between a first DC voltage pole 137 and a second DC voltage pole 138 formed by a ground return path or dedicated metallic return conductor (DMR). The first DC voltage converter 133 is set up to convert a primary-side voltage V_{DC,I} into a second-side voltage V_{DC,II}. The currents flowing through the first DC voltage converter 133 are denoted by I_{DC,I} and I_{DC,II}. The second DC voltage converter 134 has a first converter element series circuit with a third sub-converter element 139 and a second sub-converter element 140, the converter element series circuit extending between the second DC voltage pole 138 and a third DC voltage pole 141. The second DC voltage converter 134 is set up to convert a primary-side voltage, which in the example shown corresponds to the voltage V_{DC,I}, into a secondary-side voltage, which in the example shown corresponds to the voltage V_{DC,II}. The currents flowing through the first DC voltage converter 133 are denoted by I_{DC,I} and I_{DC,II}. Both DC voltage converters 133 and 134 each have an AC voltage connection 142, 143 to external AC voltage grids.

FIG. 13 illustrates a further configuration of a supply device 150. The supply device 150 comprises a DC voltage converter 151 with three sub-converter elements 152-154. The supply device 150 is set up to convert a primary-side DC terminal voltage 2*V_{DC,I} into a secondary-side DC terminal voltage 2*V_{DC,II} in order to supply a high-power load 155. The design of the supply device 150 is advantageous in particular from the view of the transistor design. It can be seen that only one high-power transformer (instead of two) is required at the second or central sub-converter element 153.

FIG. 14 illustrates a supply device 160. The supply device converts a primary-side voltage V_{DC,I} into a secondary-side voltage V_{DC,II} to supply a high-power load 161. The currents flowing through the supply device 160 are denoted in FIG. 14 on the primary side by I_{DC,I} and on the secondary side by I_{DC,}_{II}.

The supply device 160 comprises, similarly for example to the supply device 80 of FIG. 7, a DC voltage converter 162 with two sub-converter elements 163 and 164. However, in contrast to said supply device 80, the DC voltage converter 162 additionally comprises further sub-converter elements 165 and 166. The further sub-converter elements 165, 166 are arranged in a parallel circuit of the second sub-converter element 164. Thanks to the parallel connection of the sub-converter elements, it is possible to provide a higher secondary-side current I_{DC,II} without increasing the current-carrying capacity of the individual sub-converter elements themselves.

FIG. 15 shows a further supply device 170. Identical and similar elements or components are provided with the same reference signs in FIGS. 14 and 15. For reasons of clarity, the following text deals in more detail only with the differences between the supply device 170 and the supply device 160 of FIG. 14.

In contrast to the supply device 160, the supply device 170 that is illustrated by way of example comprises three parallel-connected secondary-side terminals 173-175 for connection to three high-power loads 161, 171 and 172. In this way, the supply device 170 is set up to supply three high-power loads 161, 171 and 172 at the same time. In this case, it should be noted that the number of systems/high-power loads connected in parallel on the DC low-voltage side is not restricted to three but can be scaled variably to the requirements of the system. This is considered to be advantageous especially in view of the standardization of the electrolysis systems, and also in view of the operational management and maintenance of such systems.

FIG. 16 illustrates an exemplary arrangement 200 for converting electrical energy into chemical energy to produce gas. The arrangement 200 comprises an energy generation and energy infeed system 201. The energy infeed system 201 comprises wind turbines 202, 203, 204 with associated generators 205-207, wind turbine converter elements 208-210 and with medium-voltage transformers 211-213 by means of which the wind energy is converted into electrical energy and fed into a first AC voltage grid 214. A rectifier 215 is provided and set up to convert the AC voltage of the first AC voltage grid 214 to a DC voltage and to feed same into a DC voltage grid or DC voltage line/DC voltage connection 216. The energy infeed system 201 can be arranged in the offshore region.

The power, provided as DC voltage and direct current, from wind energy is transmitted to land via the DC voltage connection 216 (which is indicated by a line 222), where the DC voltage is converted to an AC voltage by means of an inverter 217 and fed into a second AC voltage grid or a supply grid 218. The arrangement also comprises what is known as a DC chopper 219 which is set up to convert excess energy to heat losses.

The arrangement also comprises a supply device 220 for supplying a high-power load 221 in the form of an electrolysis system by means of which electrical energy is converted into chemical energy to produce gas, wherein the chemical energy is stored in the generated gas (for example H₂) and prepared for further transport. One of the exemplary embodiments of supply devices illustrated in FIGS. 4 to 15 is able to be used for example as supply device 220.

FIG. 17 illustrates an arrangement 230 for converting electrical energy into chemical energy to produce gas. Identical and similar elements or components are provided with the same reference signs in FIGS. 16 and 17. For reasons of clarity, the following text deals in more detail only with the differences between the arrangement 230 and the arrangement 200 of FIG. 16. This also applies otherwise to the subsequent FIGS. 18 and 19.

In contrast to the arrangement 200, the arrangement 230 comprises a rectifier 231 designed as a diode rectifier. This allows advantages in particular in relation to production, installation and operating costs of the rectifier.

FIG. 18 illustrates an arrangement 240 similar to the arrangement 230 of FIG. 17. In contrast to the arrangement 230, the DC chopper has been omitted in the arrangement 240. In place of this, there is a supply device 241 which is set up to be connected on the secondary side both to a high-power load 242 and to a device 243 for storing electrical energy (supercaps or high-performance battery systems) or a system for storing heat or coupling heat out. In this case, it is particularly advantageous when the aforementioned devices 243 have highly dynamic properties for buffer-storing a power imbalance.

FIG. 19 illustrates a particularly advantageous arrangement 250 similar to the arrangement 240 of FIG. 18. In contrast to the arrangement 240, a fully integrated system concept with the device 251 for including a high-power application 252 additionally takes on the role of an inverter in the arrangement 250 for converting the DC voltage into the AC voltage for feeding into the supply grid 218 (by means of a high-voltage transformer 253).

At the same time, the device 251 — in addition to the high-power application 252 — is connected to a device 254 for converting a DC power into energy that can further.

In this case, it is particularly advantageous when the device 252 and 254 have highly dynamic properties for buffer-storing a power imbalance. Bidirectional load flow properties of the devices 252 and 254 are also particularly advantageous.

It is particularly advantageous, especially for the flexibilization and achievement of a fully integrated sector coupling of the electricity and gas market, when the device 252 is set up both for electrolysis operation and fuel cell operation. In this case, the highly dynamic properties of “proton exchange membrane” (PEM) electrolysis or what is known as high-temperature electrolysis are particularly advantageous.

To this end, the circuit topologies of the device 251 together with the device of bidirectional load flow are particularly advantageous.

1-20. (canceled)

21. A supply device for a high-power load, the supply device comprising:
a voltage converter including a first sub-converter element and a second sub-converter element;
said first and second sub-converter elements being connected to one another in a converter element series circuit between first and second primary-side DC voltage poles;
said second sub-converter element being connected between first and second secondary-side DC voltage poles;
a coupling device;
said first and second sub-converter elements each having at least one AC voltage terminal connected to one another by said coupling device, permitting an exchange of electrical power between said first and second sub-converter elements; and
said first and second secondary-side DC voltage poles configured for connection to the high-power load.

22. The supply device according to claim 21, wherein:
said first sub-converter element includes at least one first phase branch extending between said first primary-side DC voltage pole and said first secondary-side DC voltage pole, and power semiconductors and a first AC voltage terminal are disposed in said first sub-converter element;
said second sub-converter element includes at least one second phase branch extending between said first secondary-side DC voltage pole and said second secondary-side DC voltage pole, and power semiconductors and a second AC voltage terminal are disposed in said second sub-converter element; and
said AC voltage terminals are connected to one another by said coupling device.

23. The supply device according to claim 22, wherein said coupling device includes a coupling transformer having a primary side connected to said first AC voltage terminal of said first sub-converter element and a secondary side connected to said second AC voltage terminal of said second sub-converter element.

24. The supply device according to claim 21, wherein the high-power load is an electrolysis system or an electric arc furnace plant.

25. The supply device according to claim 21, wherein said second sub-converter element is a line-commutated sub-converter element or a thyristor-based sub-converter element.

26. The supply device according to claim 21, wherein said second sub-converter element is a passive sub-converter element or a diode-based sub-converter element.

27. The supply device according to claim 21, wherein said second sub-converter element is a double-thyristor-based sub-converter element including antiparallel thyristors.

28. The supply device according to claim 21, wherein said first sub-converter element is a modular multilevel converter element.

29. The supply device according to claim 21, wherein said first sub-converter element includes switching modules or half-bridge switching modules for generating unipolar switching module voltages.

30. The supply device according to claim 21, wherein said first sub-converter element includes switching modules or full-bridge switching modules for generating bipolar switching module voltages.

31. The supply device according to claim 21, wherein both of said first and second sub-converter elements include at least one of half-bridge switching modules or full-bridge switching modules.

32. The supply device according to claim 21, which further comprises a DC breaker connected to one of said primary-side DC voltage poles.

33. The supply device according to claim 21, wherein said voltage converter is configured for voltage conversion at a voltage transformation ratio of a primary side to a secondary side voltage of 2 to 20.

34. The supply device according to claim 21, wherein said first and second sub-converter elements each have at least two phases.

35. The supply device according to claim 21, wherein said coupling device has a coupling terminal configured to be connected to an AC voltage grid.

36. The supply device according to claim 35, wherein said coupling terminal is a tertiary winding of a coupling transformer.

37. The supply device according to claim 21, which further comprises a third sub-converter element connected in a converter element parallel circuit having said second sub-converter element.

38. An arrangement for converting electrical energy into chemical energy to generate gas, the arrangement comprising:
a DC transmission path;
an energy generation system for providing electrical energy and for transmitting the electrical energy over said DC transmission path; and
a supply device according to claim 21, said supply device having a primary side connected to said DC transmission path.

39. The arrangement according to claim 38, wherein said energy generation system includes a rectifier connecting said energy generation system to said DC transmission path.

40. The arrangement according to claim 38, wherein said coupling device for said voltage converter has a coupling terminal connected to a supply grid.
